(19) United States
(12) Patent Application Publication
(10) Pub. No.: US 2018/0004268 A1
(43) Pub. Date: Jan. 4, 2018

(54) INFORMATION PROCESSING SYSTEM, INFORMATION PROCESSING APPARATUS, LOCATION IDENTIFICATION METHOD, AND NON-TRANSITORY COMPUTER-READABLE STORAGE MEDIUM

(71) Applicant: FUJITSU LIMITED, Kawasaki-shi (JP)

(72) Inventor: Yuika NARITA, Kawasaki (JP)

(73) Assignee: FUJITSU LIMITED, Kawasaki-shi (JP)

(21) Appl. No.: 15/629,937

(22) Filed: Jun. 22, 2017

(30) Foreign Application Priority Data
Jun. 29, 2016 (JP) 2016-129189

(51) Int. Cl. G06F 1/28; H04L 12/10; G06F 1/26

(52) U.S. Cl. CPC G06F 1/28; G06F 1/266; H04L 12/10

(57) ABSTRACT

An information processing system includes: a plurality of devices, each of the devices mounted on a rack and coupled to any one of a plurality of power outlets; and a management apparatus, wherein the management apparatus includes a processor configured to execute power control processing that includes stopping power supply to a first power outlet among the plurality of power outlets, execute determination processing that includes determining whether or not each of the plurality of devices transmits a response to a first packet from the management apparatus to the devices during the power supply to the first power outlet is stopped, and execute recording processing that includes recording identification information of a device from which a response to the first packet is not received, in association with identification information of the first power outlet.

### CROSS-REFERENCE TO RELATED APPLICATION

This application is based upon and claims the benefit of priority of the prior Japanese Patent Application No. 2016-129189, filed on Jun. 29, 2016, the entire contents of which are incorporated herein by reference.

### FIELD

The embodiments discussed herein are related to a technique for identifying a mounting location of a device.

### BACKGROUND

A large-scale system construction site (for example, data center) is provided with a large number of racks. Further, each rack is mounted with a plurality of rack mount servers, and thus thousands of rack mount servers are sometimes disposed at the site. Accordingly, it is difficult for a system administrator to visually confirm the physical mounting location of each of the rack mount servers.

In this regard, although techniques for identifying the mounting location of a network interface are known, suitable techniques for identifying the locations of the rack mount servers described above are not known.

Examples of the related art include International Publication Pamphlet No. WO 2012/157035.

### SUMMARY

According to an aspect of the invention, an information processing system includes: a plurality of devices, each of the devices mounted on a rack and coupled to any one of a plurality of power outlets; and a management apparatus, wherein the management apparatus includes a processor configured to execute power control processing that includes stopping power supply to a first power outlet among the plurality of power outlets, execute determination processing that includes determining whether or not each of the plurality of devices transmits a response to a first packet from the management apparatus to the devices during the power supply to the first power outlet is stopped, and execute recording processing that includes recording identification information of a device from which a response to the first packet is not received, in association with identification information of the first power outlet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a power distribution unit;

FIG. 2 is a diagram illustrating an example of rack mount servers supplied with power from power outlets of the power distribution unit;

FIG. 3 is a diagram illustrating a system overview according to a first embodiment;

FIG. 4 is a hardware configuration diagram of a management server;

FIG. 5 is a hardware configuration diagram of a managed device;

FIG. 6 is a functional block diagram of the power distribution unit;

FIG. 7 is a functional block diagram of a BMC;

FIG. 8 is a functional block diagram of the management server according to the first embodiment;

FIG. 9 is a diagram illustrating an example of data stored in an address storage unit;

FIG. 10 is a diagram illustrating an example of data stored in a time data storage unit;

FIG. 11 is a diagram illustrating an example of a rack table stored in a rack table storage unit;

FIG. 12 is a processing flow of the processing performed by a system according to the first embodiment;

FIG. 13 is a diagram illustrating an example of a device table stored in a device table storage unit;

FIG. 14 is a diagram illustrating an example of an association table stored in an association table storage unit;

FIG. 15 is a processing flow of the processing performed by a system according to the first embodiment;

FIG. 16 is a diagram illustrating an example of a location table stored in a location table storage unit;

FIG. 17 is a functional block diagram of the management server according to a second embodiment;

FIG. 18 is a processing flow of the processing performed by a system according to the second embodiment;

FIG. 19 is a diagram illustrating an example of data stored in a response data storage unit;

FIG. 20 is a processing flow of the processing performed by a system according to the second embodiment;

FIG. 21 is a diagram illustrating an example of data stored in a response data storage unit;

FIG. 22 is a processing flow of the processing performed by a system according to the second embodiment;

FIGS. 23A and 23B are diagrams for explaining space occupation by another managed device;

FIG. 24 is a processing flow of the processing performed by a first determination unit after the mounting location of each managed device is identified;

FIG. 25 is a processing flow of the processing performed by a first determination unit after the mounting location of each managed device is identified; and

FIG. 26 is a processing flow of the processing performed after the mounting location of each managed device is identified.

### DESCRIPTION OF EMBODIMENTS

As one aspect of the present embodiment, provided are solutions for identifying the mounting location of a rack mount server.

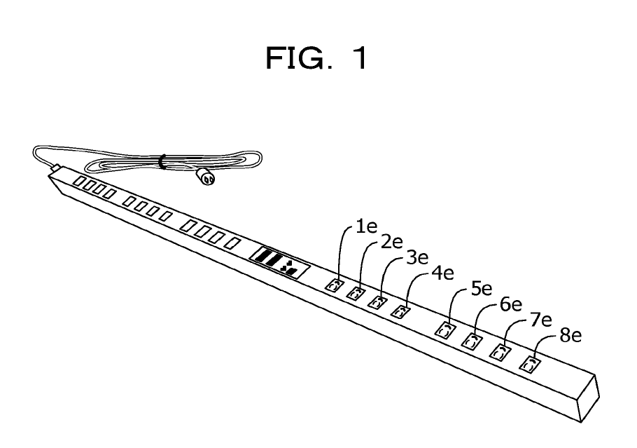

When power is supplied to each rack mount server mounted on a rack, it is possible to use a power distribution unit (also referred to as an intelligent power distribution unit (intelligent PDU)) as illustrated in FIG. 1. The power distribution unit illustrated in FIG. 1 is provided with power outlets 1e to 8e. By coupling the power plug of each rack mount server to any one of the power outlets 1e to 8e, it is possible to supply power to each rack mount server.

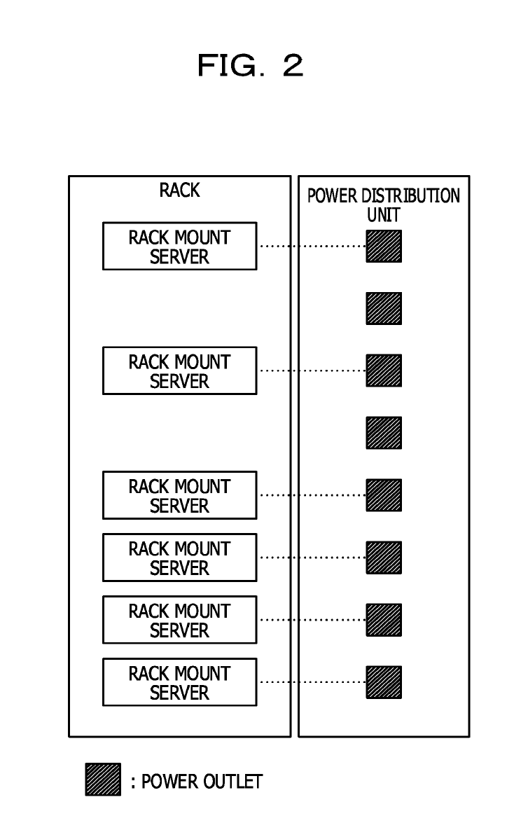

For example, as illustrated in FIG. 2, a power distribution unit is sometimes attached to a rack or disposed near the rack, and the physical location of each power outlet corresponds to the mounting location of one rack mount server. In such a case, if it is possible to identify the power outlet coupled to each rack mount server, it is possible to identify the mounting location of each rack mount server. Thus, in the present embodiment, the mounting location of a rack mount server is identified by the method described as follows.

### First Embodiment

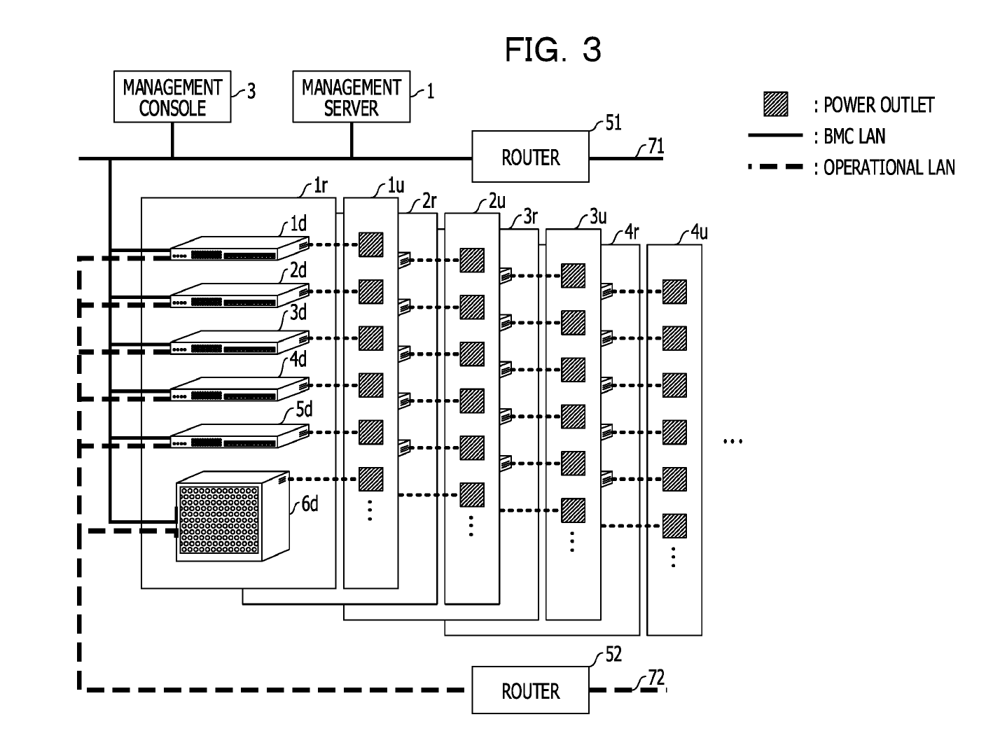

FIG. 3 illustrates a system overview according to a first embodiment. For example, a rack 1r disposed in a data center is mounted with managed devices 1d to 6d. Also, each of racks 2r to 4r is mounted with a plurality of managed devices. The managed devices are devices that are to be managed, and for example, rack mount servers. In this regard, although the number of racks is 4 in FIG. 3, the number of racks is not limited to this.

A power distribution unit is attached to each of the racks 1r to 4r. Specifically, a power distribution unit 1u is attached to the rack 1r, a power distribution unit 2u is attached to the rack 2r, a power distribution unit 3u is attached to the rack 3r, and a power distribution unit 4u is attached to the rack 4r. Each managed device is operated by power supplied from one power outlet. Each power distribution unit has functions of measuring current, voltage and supply power for each power outlet.

Each managed device is coupled to a baseboard management controller (BMC) local area network (LAN) 71 and an operational LAN 72. The BMC LAN 71 is a LAN for the BMC mounted on each managed device to perform communication, and is coupled to a management server 1, a management console 3, and a router 51. The operational LAN 72 is a LAN for performing operational communication, and is coupled to a router 52.

The management console 3 is operated by a system administrator, and transmits an instruction received from a system administrator to the management server 1. Also, the management console 3 displays notification data, and the like that have been received from the management server 1 on the screen.

The management server 1 that performs the main processing according to the present embodiment performs communication with the BMC of each managed device via the BMC LAN 71 and performs management of each managed device.

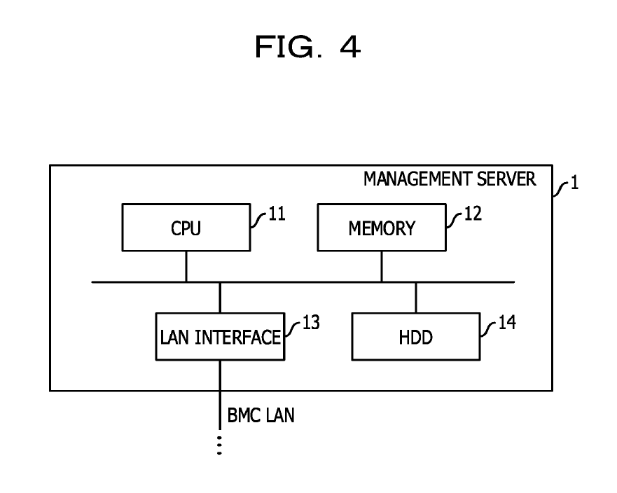

FIG. 4 is a hardware configuration diagram of the management server 1. The management server 1 includes a central processing unit (CPU) 11, a memory 12, for example, a dual inline memory module (DIMM), a LAN interface 13, for example, a network interface card (NIC), and a hard disk drive (HDD) 14. The LAN interface 13 is coupled to the BMC LAN 71.

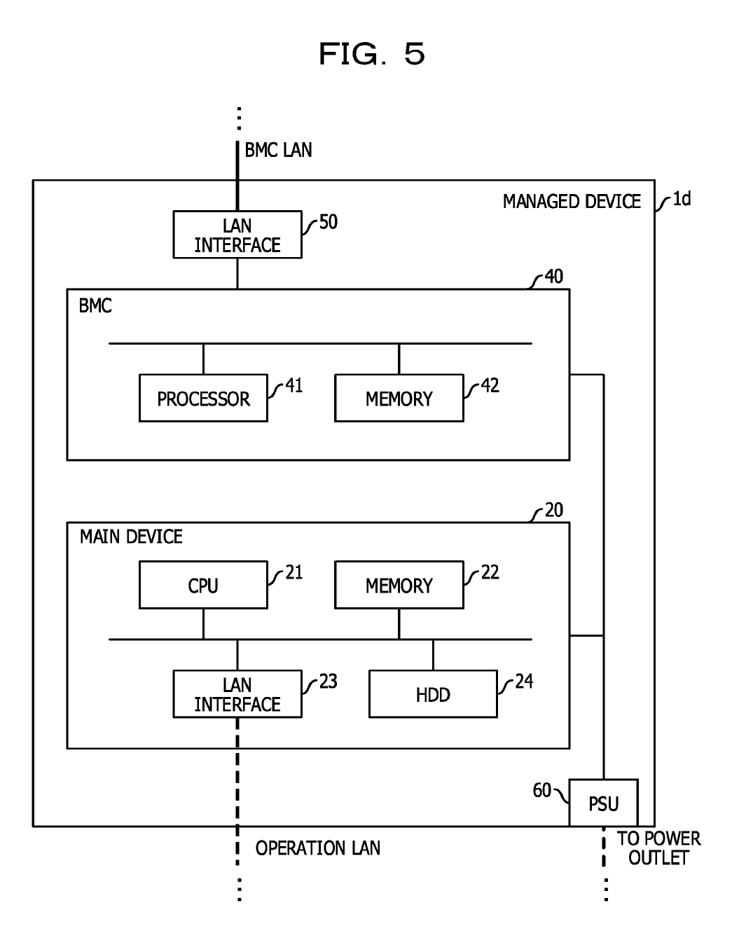

FIG. 5 is a hardware configuration diagram of the managed device 1d. The managed device 1d includes a BMC 40, a main unit 20, and a power supply unit (PSU) 60. In this regard, the hardware configuration diagrams of the managed devices other than the managed device 1d are the same as the hardware configuration diagram of the managed device 1d. The PSU 60 enables the managed device 1d to be in a state in which the BMC 40 is supplied with power, but the main unit 20 is not supplied with power. In the present embodiment, this state is referred to as a “standby state”.

The BMC 40 includes, for example, a processor 41 which is a processor for an embedded device, and a memory 42, for example, a DIMM, and is coupled to, for example, a LAN interface 50 which is a LAN port. The LAN interface 50 is coupled to the BMC LAN 71.

The main unit 20 includes a CPU 21, a memory 22, for example, a DIMM, a LAN interface 23, for example, a NIC, and an HDD 24. The LAN interface 23 is coupled to the operational LAN 72.

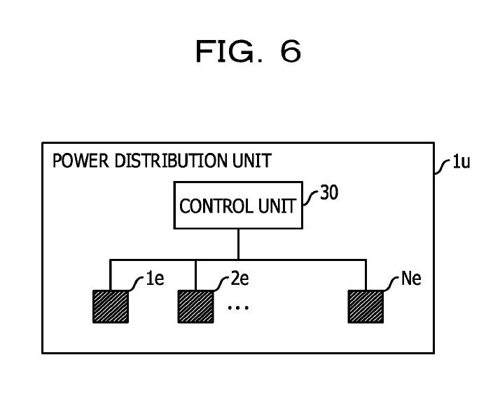

FIG. 6 illustrates a functional block diagram of the power distribution unit 1u. The power distribution unit 1u includes a control unit 30 and power outlets 1e to Ne (N is a natural number). The control unit 30 controls power supply to the power outlets 1e to Ne.

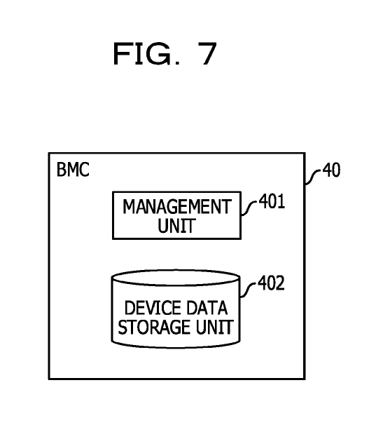

FIG. 7 is a functional block diagram of the BMC 40. The BMC 40 includes a management unit 401 and a device data storage unit 402. The device data storage unit 402 stores the information of the managed devices. The management unit 401 performs processing for managing the managed devices based on the data stored in the device data storage unit 402. In this regard, the processor 41 loads a program (for example, firmware) into the memory 42 and executes the program so as to realize the management unit 401. The device data storage unit 402 is disposed, for example, in the memory 42.

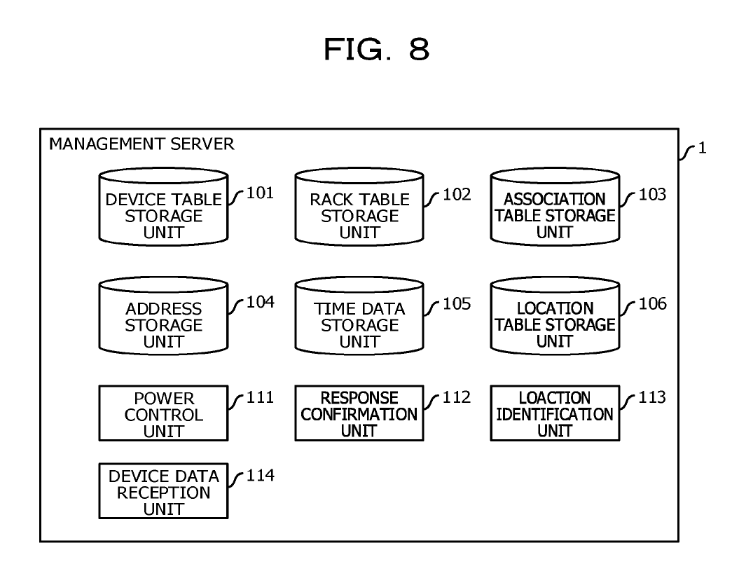

FIG. 8 is a functional block diagram of the management server 1. The management server 1 includes a device table storage unit 101, a rack table storage unit 102, an association table storage unit 103, an address storage unit 104, a time data storage unit 105, a location table storage unit 106, a power control unit 111, a response confirmation unit 112, a location identification unit 113, and a device data reception unit 114.

The power control unit 111 performs processing for controlling power that the power distribution unit supplies from each power outlet. The response confirmation unit 112 performs processing for determining whether or not a reply comes to a response request instruction (for example, the Packet InterNet Groper (PING) command) transmitted to a managed device via the BMC LAN 71. The location identification unit 113 performs processing for identifying the mounting location of each managed device. The device data reception unit 114 performs processing for receiving device data from a managed device via the BMC LAN 71.

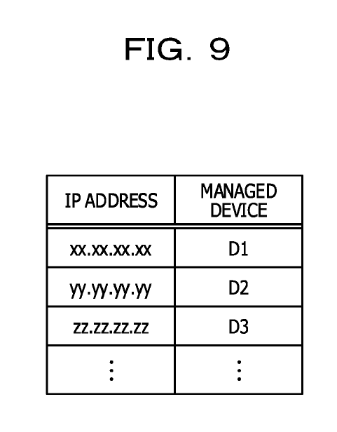

FIG. 9 illustrates an example of data stored in the address storage unit 104. In the example in FIG. 9, the Internet Protocol (IP) address of a managed device (in the present embodiment, the LAN interface 50 coupled to the BMC 40) and the identification information of the managed device are stored. In this regard, the data stored in the address storage unit 104 is provided for each rack.

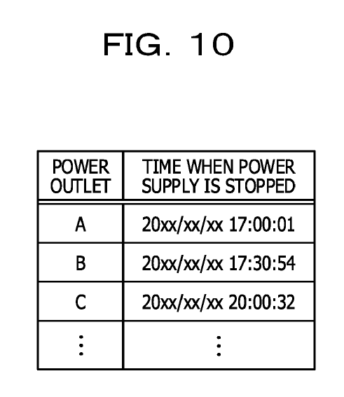

FIG. 10 illustrates an example of data stored in the time data storage unit 105. In the example in FIG. 10, the identification information of a power outlet and the time at which the power supply is stopped. The time at which the power supply is stopped is rewritten each time the power supply is stopped. In this regard, the data stored in the time data storage unit 105 is provided for each rack.

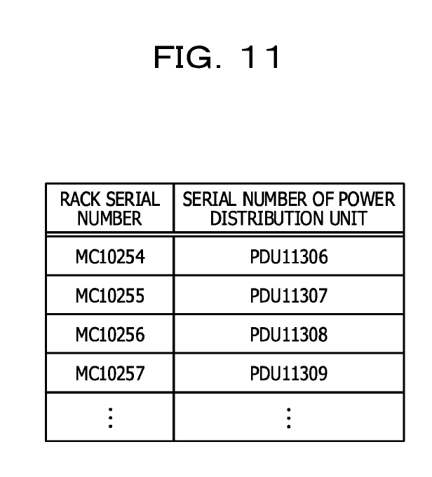

FIG. 11 illustrates an example of a rack table stored in the rack table storage unit 102. In the example in FIG. 11, the serial number of a rack and the serial number of a power distribution unit attached to the rack are stored.

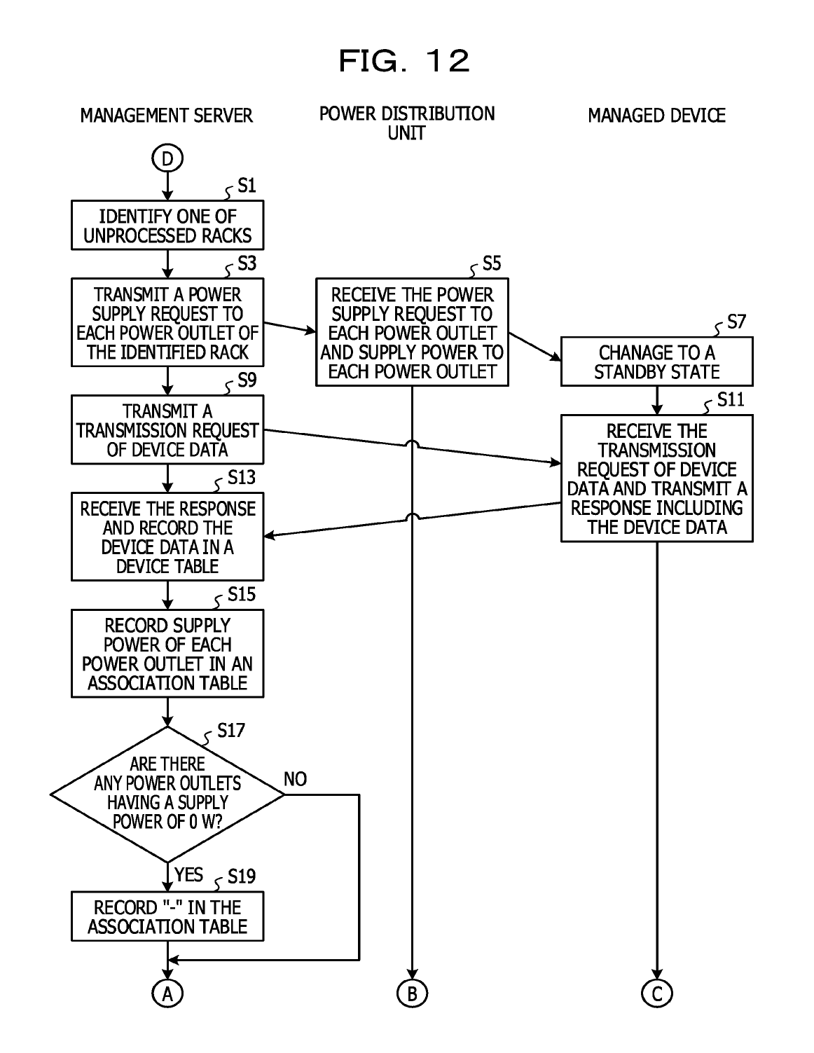

Next, a description will be given of the processing performed by the system according to the first embodiment with reference to FIG. 12 to FIG. 16.

First, the management console 3 transmits the location identification instruction received from the system administrator to the management server 1. The power control unit 111 of the management server 1 identifies one unprocessed rack (hereinafter referred to as a target rack) among the racks 1r to 4r in the system (FIG. 12: step S1).

The power control unit 111 identifies a power distribution unit (assumed to be the power distribution unit 1u here) attached to the target rack from the rack table (FIG. 11) stored in the rack table storage unit 102. The power control unit 111 then transmits, to the power distribution unit 1u, a power supply request to each power outlet of the power distribution unit 1u (step S3).

The power distribution unit 1u receives the power supply request to each power outlet. The control unit 30 of the power distribution unit 1u then supplies the power to each power outlet (step S5). Note that, in step S5, the power is supplied so that the managed device becomes a standby state, and thus the power is not supplied to the main unit 20.

Each managed device in the target rack goes to the standby state (step S7).

On the other hand, the device data reception unit 114 of the management server 1 transmits a transmission request of device data to the BMC 40 of each managed device in the target rack (step S9).

The BMC 40 of each managed device in the target rack receives the transmission request of the device data. The management unit 401 of the BMC 40 then read the device data from the device data storage unit 402 and transmits a response including the read device data to the management server 1 (step S11). The device data includes, for example, the identification information of the managed device, a unit type (for example, model), a production number, the IP address of a LAN interface 50, a media access control (MAC) address, and the power consumption.

The device data reception unit 114 of the management server 1 receives the response including the device data from the BMC 40 of the managed device. The device data reception unit 114 then records the received device data in the device table stored in the device table storage unit 101 (step S13).

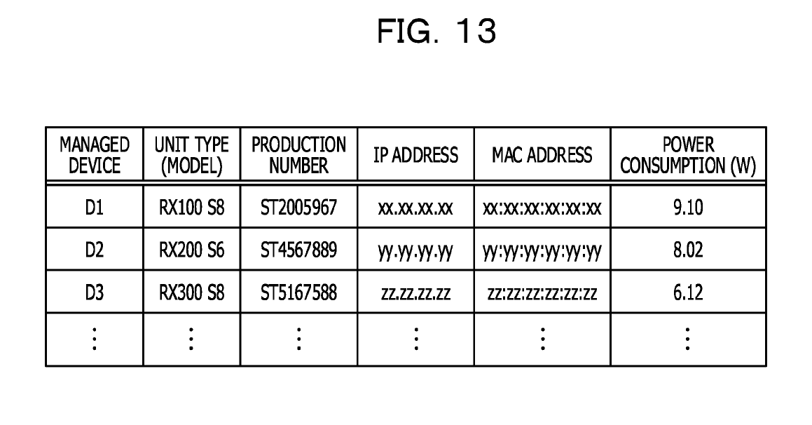

FIG. 13 illustrates an example of data stored in the device table. The example in FIG. 13 includes the identification information of the managed device, a unit type, a production number, the IP address of a LAN interface 50, a MAC address, and the power consumption. The device table is provided for each rack. The power distribution unit according to the present embodiment has a function of measuring the power consumption of the managed device coupled to the power outlet, and thus the power consumption measured by the power distribution unit is obtained by the BMC 40 and is recorded in the device table.

The power control unit 111 obtains the information of the supply power of each power outlet from the power distribution unit 1u and records the information in the association table storage unit 103 (step S15). In this regard, if the managed device is not coupled to the power outlet, the power is not consumed so that the supply power is 0 watt (W).

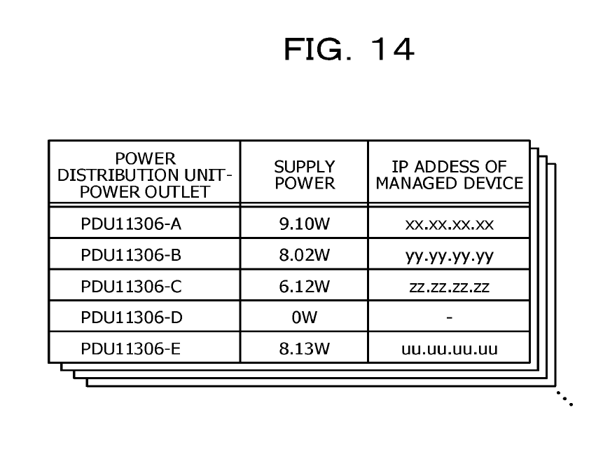

FIG. 14 illustrates an example of an association table stored in the association table storage unit 103. The example in FIG. 14 stores the information including the identification information of a power distribution unit and the identification information of a power outlet, the information of the supply power obtained from the power distribution unit 1u, and the IP address of a managed device (the IP address of the LAN interface 50 coupled to the BMC 40 of a managed device here). In this regard, at a processing point in time of step S3, nothing is stored in the field of the IP address of the managed device. In this regard, the association table is provided for each rack.

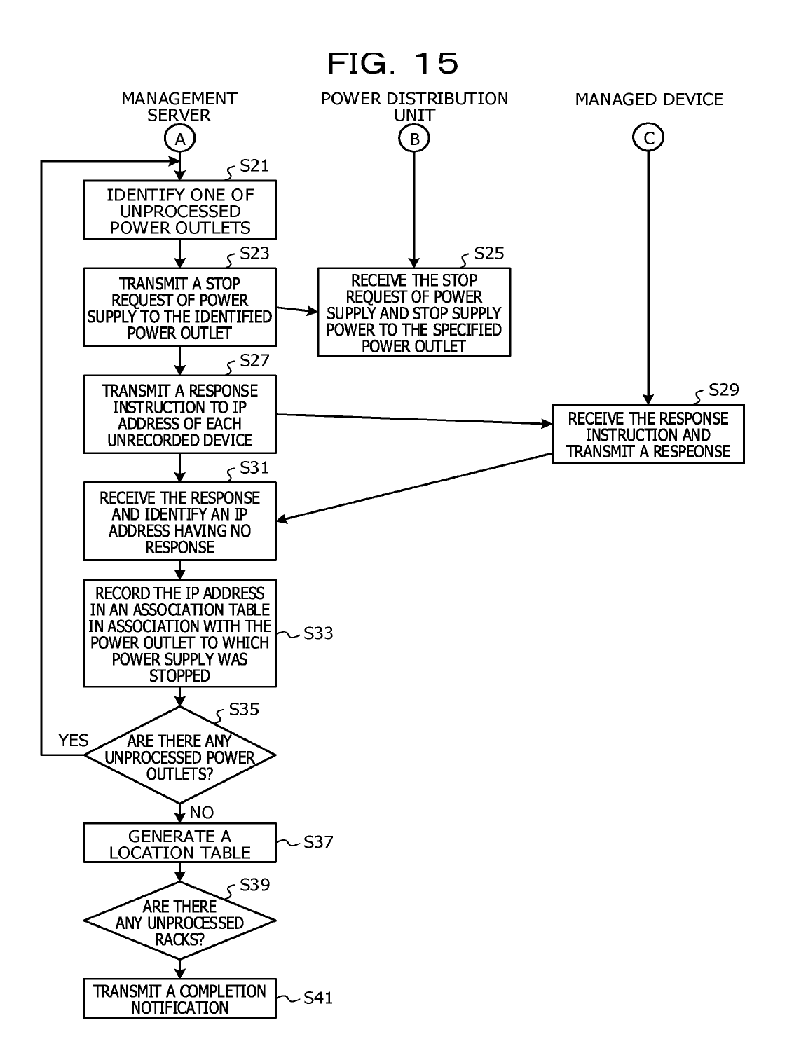

The location identification unit 113 determines whether or not there are power outlets whose supply power recorded in the association table (FIG. 14) is 0 W (step S17) among the power outlets of the power distribution unit 1u. If there is a power outlet having the supply power of 0 W (step S17: Yes), the location identification unit 113 records a symbol “-” indicating that there are no coupled managed devices for the power outlet having the supply power of 0 W in the association table (FIG. 14) (step S19). The processing then proceeds to the illustration in FIG. 15 via connectors A to C. On the other hand, if there are no power outlets having the supply power of 0 W (step S17: No), the processing proceeds to the illustration in FIG. 15 via the connectors A to C.

Referring to the illustration in FIG. 15, the power control unit 111 identifies one of the unprocessed power outlets among the power outlets of the power distribution unit 1u (FIG. 15: step S21). The unprocessed power outlets are identified, for example, in the order from the top of the target rack.

The power control unit 111 transmits to the power distribution unit 1u a stop request of power supply to the identified power outlet (step S23). The stop request includes the identification information of the power outlet identified in step S21. In this regard, the time data storage unit 105 stores information of the stop time regarding the identified power outlet.

The power distribution unit 1u receives the stop request of the power supply. The control unit 30 of the power distribution unit 1u then stops the power supply to the power outlet specified in the stop request (step S25).

On the other hand, the response confirmation unit 112 of the management server 1 transmits a response request instruction to each of the IP addresses of the managed devices whose IP addresses are not recorded in the association table (FIG. 14) (note that the managed devices having the symbol “-” recorded in the association table are excluded. Hereinafter the managed devices whose IP addresses are not recorded are referred to as unrecorded devices) (step S27).

The BMC 40 of the managed device that received the response request instruction transmits a response to the response request instruction to the management server 1 (step S29).

The response confirmation unit 112 of the management server 1 receives the response to the response request instruction. The response confirmation unit 112 then identifies an IP address from which a response to the response request instruction has not been obtained (step S31). If a response to the response request instruction is not obtained within a predetermined period of time after transmitting the response request instruction, the power supply to the power outlet is stopped, or the managed device is not coupled to the power outlet.

The location identification unit 113 records the IP address identified in step S31 in the association table (FIG. 14) in association with the identification information of the power outlet to which the power supply is stopped in step S25 (step S33).

The response confirmation unit 112 determines whether or not there are unprocessed power outlets (step S35). If there is an unprocessed power outlet (step S35: Yes), the processing returns to the processing in step S21. On the other hand, if there are no unprocessed power outlets (step S35: No), the location identification unit 113 generates a location table from the association table (FIG. 14) stored in the association table storage unit 103 and the rack table (FIG. 11) stored in the rack table storage unit 102 (step S37), and stores the location table in the location table storage unit 106.

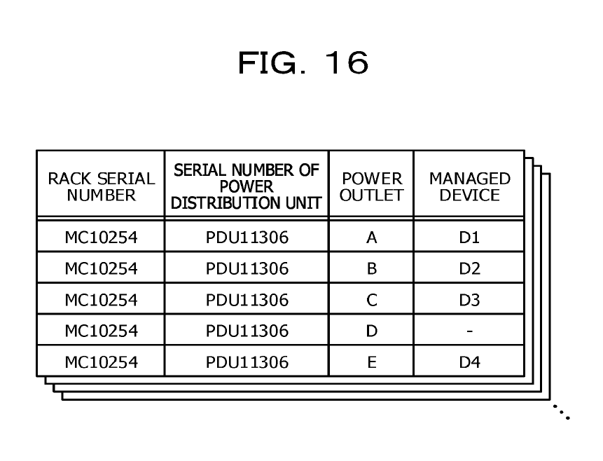

FIG. 16 illustrates an example of a location table stored in the location table storage unit 106. The example in FIG. 16 stores the serial number of a rack, the serial number of a power distribution unit, the identification information of a power outlet, and the identification information of a managed device. By the location table, a managed device is identified to be coupled to which power outlet in which rack. The power outlets having adjacent entries in the location table are adjacent to each other on the power distribution unit.

The location identification unit 113 determines whether or not there are unprocessed racks (step S39). If there is an unprocessed rack (step S39: Yes), the processing returns to step S1 in FIG. 12 via connector D. If there are no unprocessed racks (step S39: No), the location identification unit 113 transmits a completion notification indicating the completion of the identification of the location to the management console 3 (step S41). Thereby, it is possible for the operator of the management console 3 to know that the identification of the mounting location of each managed device has been completed.

By performing the processing as described above, it becomes possible to automatically identify the mounting location of each managed device mounted on a rack without introducing a special equipment, for example, a rack provided with a location sensor, or the like. Also, it is possible to reduce the occurrence of mistakes compared with the case where the administrator visually checks a location.

### Second Embodiment

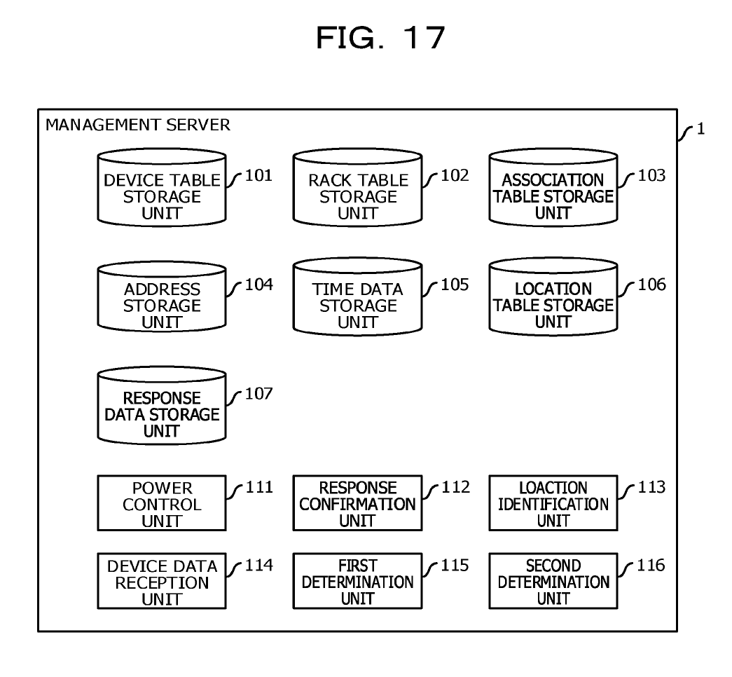

FIG. 17 is a functional block diagram of the management server 1 according to a second embodiment. The management server 1 includes a device table storage unit 101, a rack table storage unit 102, an association table storage unit 103, an address storage unit 104, a time data storage unit 105, a location table storage unit 106, a response data storage unit 107, a power control unit 111, a response confirmation unit 112, a location identification unit 113, a device data reception unit 114, a first determination unit 115, and a second determination unit 116.

The power control unit 111 performs the processing for controlling the power supplied by the power distribution unit to each power outlet. The response confirmation unit 112 performs the processing for determining whether or not a response comes against a response request instruction transmitted to the managed device via the BMC LAN 71. The location identification unit 113 performs the processing for identifying the mounting location of each managed device. The device data reception unit 114 performs the processing for receiving device data from the managed device via the BMC LAN 71. The first determination unit 115 performs the processing for determining whether or not to identify the mounting location of the managed device if a managed device is replaced or newly coupled. The second determination unit 116 performs the processing for determining whether or not to stop the power supply to a certain power outlet.

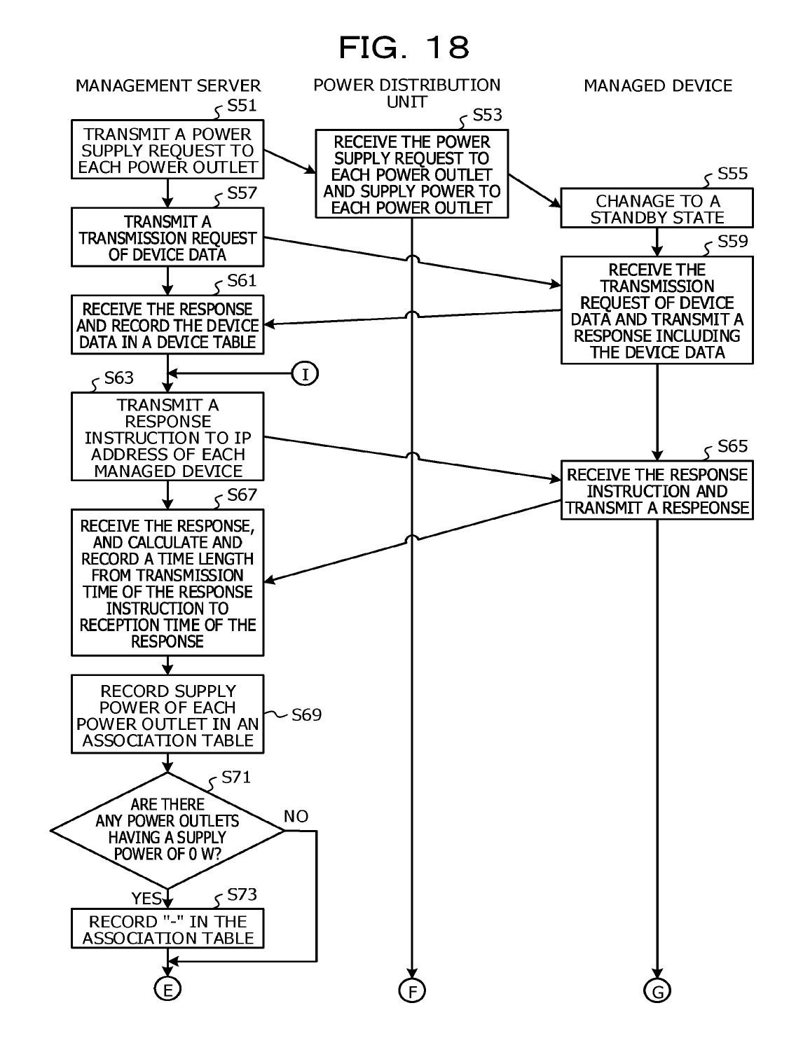

Next, a description will be given of the processing performed by a system according to the second embodiment with reference to FIG. 18 to FIG. 26. In order to simplify the description, the description will be given by taking the case of performing the processing of a single rack as an example.

First, the management console 3 transmits the location identification instruction received from the system administrator to the management server 1. The power control unit 111 of the management server 1 transmits a power supply request to each power outlet of the power distribution unit (assumed to be the power distribution unit 1u here) attached to the target rack to the power distribution unit 1u (FIG. 18: step S51).

The power distribution unit 1u receives the power supply request to each power outlet. The control unit 30 of the power distribution unit 1u supplies the power to each power outlet (step S53). However, in step S53, the power is supplied such that the managed device goes to the standby state, and thus the power is not supplied to the main unit 20.

Each managed device mounted on the target rack goes to the standby state (step S55).

On the other hand, the device data reception unit 114 of the management server 1 transmits a transmission request of the device data to the BMC 40 of each managed device in the target rack (step S57).

The BMC 40 of each managed device in the target rack receives the transmission request of the device data. The management unit 401 of the BMC 40 then reads the device data from the device data storage unit 402, and transmits a response including the read device data to the management server 1 (step S59). The device data includes, for example, the identification information of a managed device, a unit type (for example, model), a production number, the IP address of a LAN interface 50, a media access control (MAC) address, power consumption, and the size of the managed device.

The device data reception unit 114 of the management server 1 receives the response including the device data from the BMC 40 of the managed device. The device data reception unit 114 then records the received device data in the device table stored in the device table storage unit 101 (step S61). The device data recorded in step S61 includes the size information of the managed device in addition to the data illustrated in FIG. 13.

The response confirmation unit 112 transmits a response request instruction to the IP address of each managed device mounted on the target rack (step S63). The response confirmation unit 112 then stores the time at which the response request instruction was transmitted in the response data storage unit 107.

The BMC 40 of the managed device that has received the response request instruction transmits a response to the response request instruction to the management server 1 (step S65).

The response confirmation unit 112 of the management server 1 receives the response to the response request instruction, and stores the time when the response was received in the response data storage unit 107. The response confirmation unit 112 then calculates the time length from the transmission time of the response request instruction to the reception time of the response based on the data stored in the response data storage unit 107, and records the time length in the response data storage unit 107 (step S67).

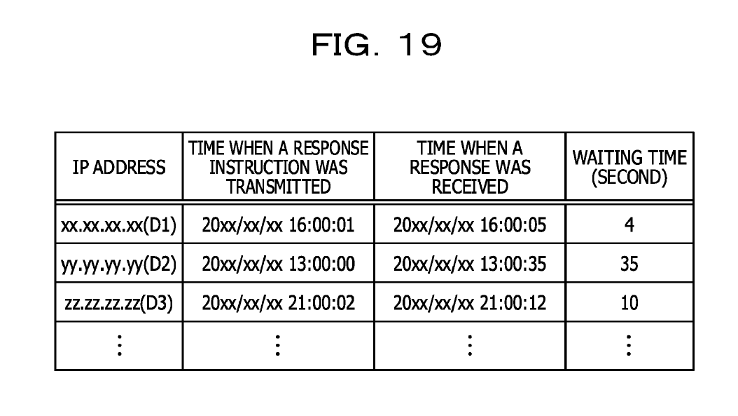

FIG. 19 illustrates an example of the data stored in a response data storage unit 107. The example in FIG. 19 stores the IP address, the time when the previous response request instruction was transmitted, the time when the previous response was received, the time length (that is to say, waiting time) from the transmission time to the reception time for each managed device.

The power control unit 111 obtains the information of the supply power of each power outlet from the power distribution unit 1u, and records the information in the association table storage unit 103 (step S69). In this regard, if the managed device is not coupled to a power outlet, the power is not consumed, and thus the supply power is 0 watt (W).

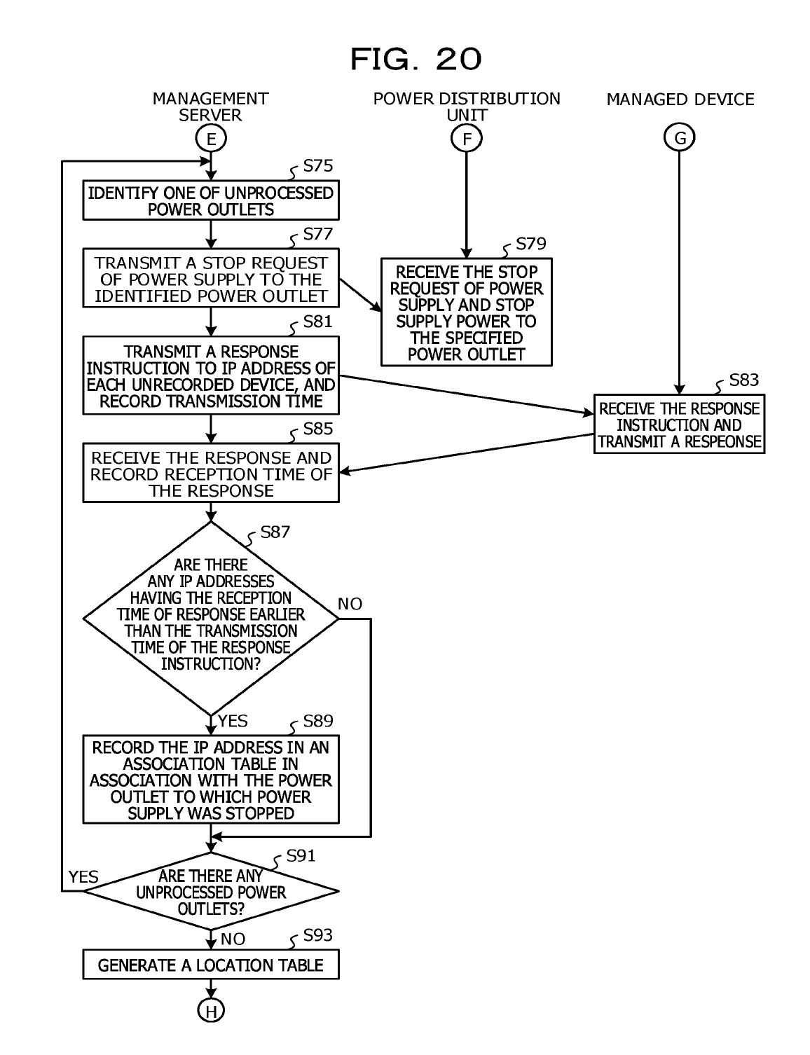

The location identification unit 113 determines whether or not there are power outlets whose supply power recorded in the association table (FIG. 14) is 0 W among the power outlets of the power distribution unit 1u (step S71). If there is a power outlet whose supply power is 0 W (step S71: Yes), the location identification unit 113 records the symbol “-” indicating that there are no managed devices coupled to the power outlet whose supply power is 0 W in the association table (FIG. 14) (step S73). Next, the processing proceeds to the illustration in FIG. 20 via connectors E to G. On the other hand, if there are no power outlets whose supply power is 0 W (step S71: No), the processing proceeds to the illustration in FIG. 20 via connectors E to G.

Referring to the illustration in FIG. 20, the power control unit 111 identifies one unprocessed power outlet out of the power outlets of the power distribution unit 1u (FIG. 20: step S75). The unprocessed power outlets are identified, for example, in the order from the top of the target rack.

The power control unit 111 transmits to the power distribution unit 1u a stop request of power supply to the identified power outlet (step S77). The stop request includes the identification information of the power outlet identified in step S75. In this regard, the time data storage unit 105 stores information of the stop time regarding the identified power outlet.

The power distribution unit 1u receives the stop request of the power supply. The control unit 30 of the power distribution unit 1u then stops the power supply to the power outlet specified in the stop request (step S79).

On the other hand, the response confirmation unit 112 of the management server 1 transmits a response request instruction to each of the IP addresses of the managed devices (Note that the managed devices having the symbol “-” recorded in the association table. Hereinafter referred to as unrecorded devices) whose IP addresses are not recorded in the association table (FIG. 14) (step S81). The response confirmation unit 112 then stores the time at which the response request instruction is transmitted in the response data storage unit 107. If the transmission time of the response is already stored, the transmission time is overwritten on the transmission time already written.

The BMC 40 of the managed device that has received the response request instruction transmits a response to the response request instruction to the management server 1 (step S83).

The response confirmation unit 112 of the management server 1 receives the response to the response request instruction, and records the reception time of the response in the response data storage unit 107 (step S85). If the reception time of the response is already stored, the reception time is overwritten on the reception time already written.

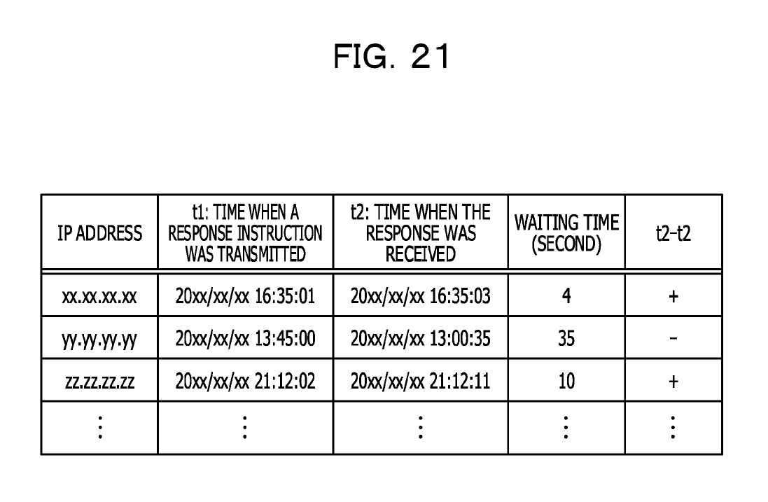

The response confirmation unit 112 determines whether or not there area IP addresses whose reception time of a response is earlier than the transmission time of a response request instruction in the response data storage unit 107 (step S87). For example, if the data illustrated in FIG. 21 is stored in the response data storage unit 107, for the IP address “yy.yy.yy.yy”, the time when the response was received is earlier than the time when the response request instruction was transmitted. This means that the response to the response request instruction transmitted at the previous time has not been received.

If there are no IP addresses whose reception time of a response is earlier than the transmission time of a response request instruction in the response data storage unit 107 (step S87: No), the processing proceeds to the processing in step S91. On the other hand, if there is an IP address whose reception time of a response is earlier than the transmission time of a response request instruction in the response data storage unit 107 (step S87: Yes), the location identification unit 113 records the IP address in association with the identification information of the power outlet to which the power supply has been stopped in step S79 in the association table (FIG. 14) (step S89).

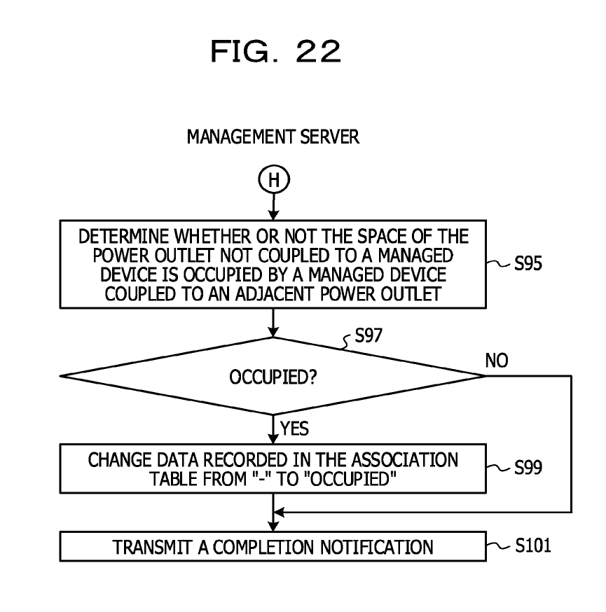

The response confirmation unit 112 determines whether or not there are unprocessed power outlets (step S91). If there is an unprocessed power outlet (step S91: Yes), the processing returns to the processing in step S75. On the other hand, if there are no unprocessed power outlets (step S91: No), the location identification unit 113 generates (step S93) a location table (FIG. 16) from the association table (FIG. 14) stored in the association table storage unit 103 and the rack table (FIG. 11) stored in the rack table storage unit 102, and stores the location table in the location table storage unit 106. The processing then proceeds to step S95 in FIG. 22 via connector H.

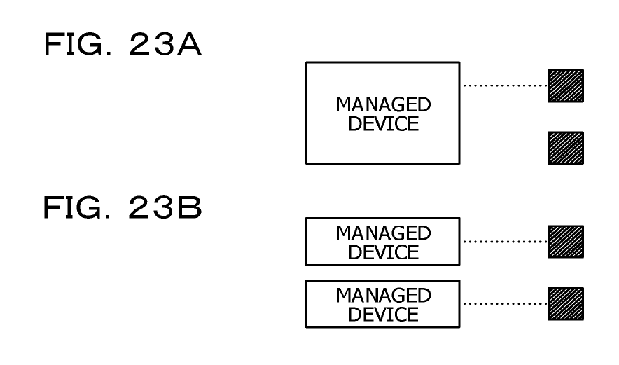

Referring to the illustration in FIG. 22, the location identification unit 113 determines whether or not the space of the power outlet (that is to say, the power outlet having the symbol “-” recorded in the location table (FIG. 16)) that is not coupled to a managed device is occupied by a managed device coupled to an adjacent power outlet (FIG. 22: step S95). A description will be given of occupation of a space by another managed device with reference to FIGS. 23A and 23B. As illustrated in FIG. 23A, in the case of two power outlets, if a managed device coupled to one of the power outlets prohibits the other of the power outlets from being coupled to a managed device, the space of another power outlet is occupied. On the other hand, as illustrated in FIG. 23B, if a managed device having a normal size (for example, 1U (unit)) is coupled to each power outlet, the space of each power outlet is not occupied by a managed device coupled to another power outlet.

If the space of the power outlet not coupled to a managed device is not occupied by a managed device coupled to an adjacent power outlet (step S97: No), the processing proceeds to step S101. On the other hand, if the space of the power outlet not coupled to a managed device is occupied by a managed device coupled to an adjacent power outlet (step S97: Yes), the location identification unit 113 changes the data recorded in the location table (FIG. 16) for the power outlet not coupled to a managed device from the symbol “-” indicating that a managed device is not coupled to “occupied” (step S99). Further, the location identification unit 113 transmits, to the power distribution unit 1u, a complete stop request of the power supply to the power outlet whose space is occupied. Thereby, the power supply is stopped to the BMC 40 of the power outlet whose space is occupied, and thus it is possible to reduce the power consumption.

The location identification unit 113 transmits a completion notification indicating the completion of the identification of the location to the management console 3 (step S101). Thereby, it is possible for the operator of the management console 3 to know that the identification of the mounting location of each managed device has been completed.

By performing the processing as described above, it becomes possible to determine whether or not there are responses by a reasonable method. Accordingly, it becomes possible to determine that there are no responses while a response actually has come, and to reduce the situation of continuing to wait for a response while there is no chance of receiving a response.

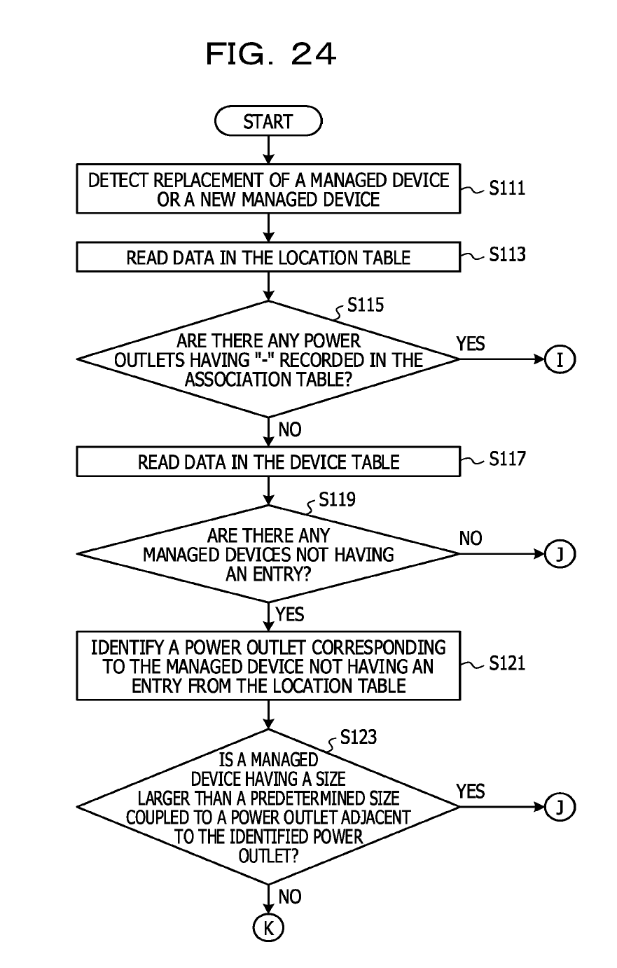

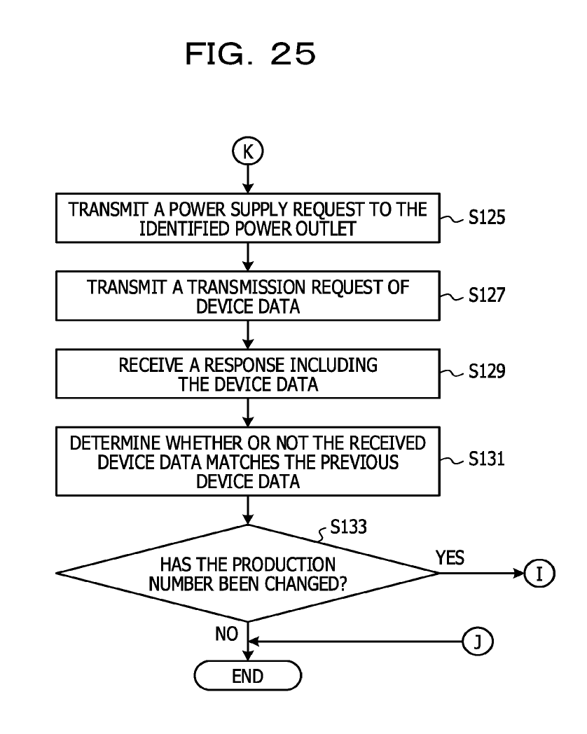

Next, a description will be given of the processing performed by the first determination unit 115 after the mounting location of each managed device with reference to FIG. 24 and FIG. 25.

First, the first determination unit 115 detects that a managed device is replaced or a new managed device is coupled to the power outlet by, for example, a packet transmitted from a managed device (FIG. 24: step S111).

The first determination unit 115 reads the data in the location table (FIG. 16) stored in the location table storage unit 106 (step S113).

The first determination unit 115 determines whether or not there are entries of the power outlets for which the symbol “-” indicating that there are no coupled managed devices are recorded in the association table (FIG. 14) stored in the association table storage unit 103 (step S115).

If there is an entry of a power outlet for which the symbol “-” indicating that there are no coupled managed devices are recorded in the association table (step S115: Yes), it is thought that a new managed device has been coupled to the power outlet. Accordingly, the processing proceeds to step S63 in FIG. 18 via connector I, and the mounting location of the new managed device is identified.

On the other hand, if there are no entries of power outlets for which the symbol “-” indicating that there are no coupled managed devices are recorded in the association table association table (step S115: No), the first determination unit 115 reads the data in the device table stored in the device table storage unit 101 (step S117).

The first determination unit 115 determines whether there is a managed devices having no entry although the entry is generated when the mounting location of each managed device is identified in the device (step S119). A list of entries when the mounting location of each managed device is identified is assumed to be, for example, separately stored in the memory, or the like. If there are no such managed devices (step S119: No), the processing proceeds to FIG. 25 via connector J.

On the other hand, if there are no such managed devices (step S119: Yes), the first determination unit 115 identifies (step S121) a power outlet corresponding to the identification information of the managed device whose entry has disappeared from the location table (FIG. 16).

The first determination unit 115 determines whether or not a managed device having a size larger than a predetermined size (for example, 1U) is coupled to the power outlet adjacent to the power outlet identified in step S121 based on the data in the device table and the data in the location table (FIG. 16) (step S123).

If a managed device having a size larger than a predetermined size is coupled to the power outlet adjacent to the power outlet identified in step S121 (step S123: Yes), the space of the power outlet identified in step S121 is occupied by a managed device coupled to the adjacent power outlet. Accordingly, the processing for identifying the mounting location may not be performed. The processing proceeds to FIG. 25 via connector J.

On the other hand, a managed device having a size larger than a predetermined size (for example, 1U) is not coupled to the power outlet adjacent to the power outlet identified in step S121 (step S123: No), there is a possibility that the managed device has been replaced. Thus, the processing proceeds to step S125 in FIG. 25 via connector K.

Referring to the illustration in FIG. 25, the first determination unit 115 transmits a power supply request to the power outlet identified in step S121 to the power distribution unit having the power outlet (FIG. 25: step S125). In response to this, the power distribution unit starts supplying power to the power outlet identified in step S121, and the managed device coupled to the power outlet goes to a standby state.

The device data reception unit 114 transmits a transmission request of the device data to the BMC 40 of the managed device coupled to the power outlet identified in step S121 (step S127). The management unit 401 of the BMC 40 of the managed device that has received the transmission request reads the device data from the device data storage unit 402, and transmits a response including the read device data to the management server 1. The device data includes, for example, the identification information of the managed device, a unit type (for example, model), a production number, the IP address of a LAN interface 50, a MAC address, power consumption, and the size of the managed device.

The device data reception unit 114 of the management server 1 receives the response including the device data from the BMC 40 of the managed device (step S129).

The first determination unit 115 determines whether or not the device data received in step S129 matches the device data in the device table in the device data storage unit 402 (step S131).

The first determination unit 115 determines whether or not the production number included in the device data has been changed (step S133). If the production number has been changed (step S133: Yes), in order to perform the processing for identifying the mounting location, the processing proceeds to step S63 in FIG. 18 via connector I. On the other hand, if the production number has not been changed (step S133: No), the processing is terminated.

By performing the processing as described above, the chances to perform the processing for identifying the mounting location are limited, and thus it becomes possible to reduce the processing load of the management server 1.

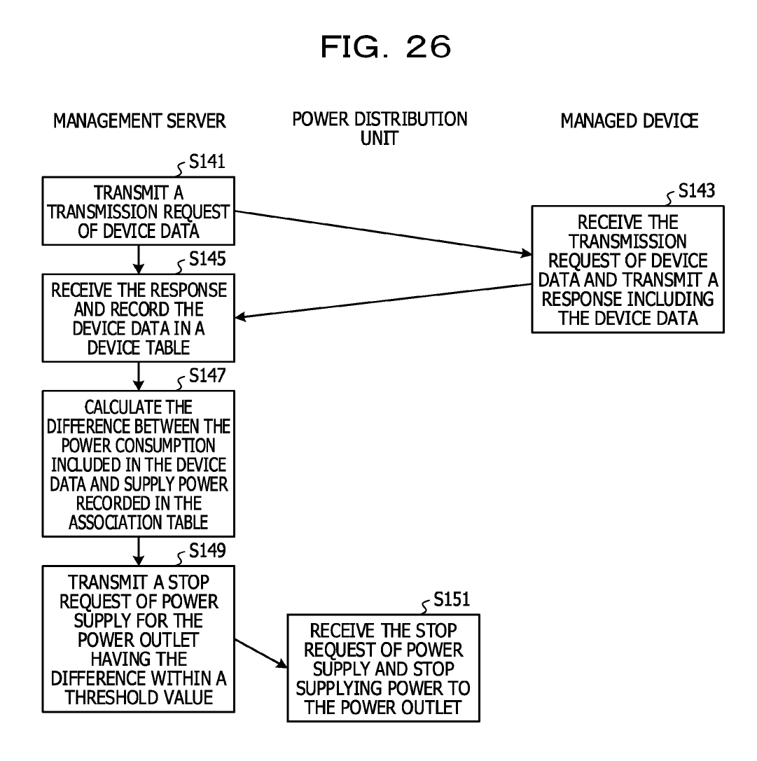

Next, with reference to FIG. 26, a description will be given of the determination processing performed mainly by the second determination unit 116 after the mounting location of each managed device is identified.

First, the device data reception unit 114 of the management server 1 transmits a transmission request of device data to the BMC 40 of each managed device in each rack (FIG. 26: step S141).

The BMC 40 of each managed device in each rack receives the transmission request of the device data. The management unit 401 of the BMC 40 reads the device data from the device data storage unit 402, and transmits a response including the read device data to the management server 1 (step S143). The device data includes, for example, the identification information of the managed device, a unit type (for example, model), a production number, the IP address of a LAN interface 50, a MAC address, power consumption, and the size of the managed device.

The device data reception unit 114 of the management server 1 receives the response including the device data from the BMC 40 of the managed device. The device data reception unit 114 then records the received device data in the device table (FIG. 13) stored in the device table storage unit 101 (step S145).

The second determination unit 116 calculates (step S147) the difference between the power consumption included in the device data recorded in the device table (FIG. 13) for each managed device in each rack and the supply power recorded in the association table (FIG. 14).

The second determination unit 116 transmits a stop request of the power supply to the power distribution unit having the power outlet (step S149) for the power outlet coupled to the managed device having the difference calculated in step S147 within the threshold value. The stop request of the power supply includes the identification information of the power outlet to which the power supply is stopped. The fact that the difference is within a threshold value means that the managed device is still in the standby state.

The power distribution unit that has received the stop request of the power supply stops the power supply to the power outlet specified in the stop request of the power supply (step S151).

By performing the processing as described above, if the processing of the main unit 20 has not been started and the managed device is still in the standby state, it becomes possible to reduce the power consumption by stopping the power supply. For example, in the case where the average power consumption in the standby state is 8 W, by stopping the power supply to the 1000 managed devices that are in standby states, it becomes possible to save 8000 W.

The descriptions have been given of the embodiments of the present disclosure, but the present disclosure is not limited to these. For example, the functional block configurations of the management server 1 described above, the power distribution unit, and the BMC 40 are sometimes different from the actual program module configurations.

Also, each table structure described above is only one example, and does not have to be configured as described above. Further, in the processing flows, it is possible to replace the processing order as long as the same processing result is obtained. Further, the processing may be performed in parallel.

For example, in the determination as to whether a managed device is coupled to a power outlet, in the case where the power consumption to the power outlet is used, but a response including device data does not come, the symbol “-” indicating that there are no coupled managed devices may be recorded.

The above-described embodiments of the present disclosure are summarized as follows.

An information processing system according to a first aspect to the present embodiment includes (A) a plurality of devices each of which is mounted on a rack and coupled to any one of a plurality of power outlets, and (B) a management apparatus. The management apparatus includes (b1) a power control unit that stops the power supply to the first power outlet among a plurality of power outlets, (b2) a determination unit that determines whether or not each of the plurality of devices transmits a response to a first packet that the management apparatus has transmitted to the device, and (b3) a recording unit that records the identification information of a device that does not transmits a response to the first packet among the plurality of devices in association with the identification information of the first power outlet.

With the above-described configuration, it is possible to identify a power outlet coupled to a device, and thus it becomes possible to identify mounting location of the device in the rack.

Also, the recording unit may record (b31) the first information indicating that there are no coupled devices in association with the identification information of the second power outlet to which the power is not supplied among the plurality of power outlets. It becomes possible to identify not only the mounting location of the device, but the location having not a device.

Also, the management apparatus may further include a device management unit that receives (b4) the device information including the size information of the device from each of the plurality of devices and identifies a first device having a size larger than a predetermined size among the plurality of devices. Also, the recording unit may record (b32) the second information indicating that the space is occupied by another device in association with the identification information of the third power outlet that is adjacent with the power outlet coupled to the first device and is associated with the first information. It becomes possible to suitably get the state of a plurality of power outlets even if there are devices having different sizes. Also, when the space is occupied by another device, the power is not consumed by the third power outlet, and thus it becomes possible to reduce the power supply power consumption by completely stop the power supply.

Also, the management apparatus may further include (b5) a first comparison unit that determines, if a device coupled to a fourth power outlet among a plurality of power outlets is replaced, whether or not the device information of the device coupled to the fourth power outlet before replacement matches the device information of the device coupled to the fourth power outlet after the replacement. If the devices before the replacement and after the replacement match, it is possible to omit the processing for identifying the mounting location of the device, and thus it becomes possible to reduce the processing load.

Also, the device information received from each of the plurality of devices may further include the information of the power consumption of the device. The management apparatus may further include (b6) a second comparison unit that determines whether or not the difference between the power consumed by the fifth power outlet among the plurality of power outlets at a first timing when at least some of the plurality of devices are in operation and the power supplied from the fifth power outlet at a second timing before starting the operation of the plurality of devices is less than or equal to a predetermined value. If (a1) the second comparison unit determines that the difference is less than or equal to a predetermined value, the power control unit may stop the power supply to the fifth power outlet. The device coupled to the fifth power outlet is not used for operation, and thus by stopping the power supply, it becomes possible to reduce the power consumption.

Also, the determination unit (b21) may calculate the time length from the time when the management apparatus transmits a second packet to the device to the time when a response to the second packet is received before the management apparatus transmits a first packet to the device for each of the plurality of devices, and (b22) may determine whether or not each of a plurality of devices transmits a response to the first packet until the time length passes after the transmission of the first packet. It becomes possible to determine whether or not there is a response to the first packet by an adequate method.

A location identification method according to a second aspect to the present embodiment includes the processing for (C) stopping the power supply to the first power outlet among the plurality of power outlets among, (D) each of the plurality of devices mounted on a rack and coupled to any one of a plurality of power outlets determining whether or not to transmit a response to the first packet the computer has transmitted to that device, and (E) recording the identification information of the device that does not transmit a response to the first packet among the plurality of devices in association with the identification information of the first power outlet.

In this regard, it is possible to create a program for causing a processor to perform the processing by the above-described method. The program is stored, for example, in a computer-readable storage medium, or a storage device, such as a flexible disk, a CD-ROM, a magneto-optical disc, a semiconductor memory, a hard disk, or the like. In this regard, the intermediate processing result is temporarily stored in a storage device, such as a main memory, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a plurality of devices, each of the devices mounted on a rack and coupled to any one of a plurality of power outlets; and
a management apparatus,
wherein the management apparatus includes a processor configured to
execute power control processing that includes stopping power supply to a first power outlet among the plurality of power outlets,
execute determination processing that includes determining whether or not each of the plurality of devices transmits a response to a first packet from the management apparatus to the devices during the power supply to the first power outlet is stopped, and
execute recording processing that includes recording identification information of a device from which a response to the first packet is not received, in association with identification information of the first power outlet.

2. The information processing system according to claim 1,
wherein the recording processing includes recording first information indicating that there are no coupled devices in association with identification information of a second power outlet without power supply among the plurality of power outlets.

3. The information processing system according to claim 2,
wherein the processor of the management apparatus is further configured to
execute device management processing that includes receiving device information including size information of the device from each of the plurality of devices, and identifying a first device having a size equal to or larger than a predetermined size among the plurality of devices,
wherein the recording processing includes associating identification information of a third power outlet adjacent to the power outlet coupled to the first device and associated with the first information, and recording second information indicating that space is occupied by another device.

4. The information processing system according to claim 3,
wherein the processor of the management apparatus is further configured to
execute first comparison processing that includes if a device coupled to a fourth power outlet among the plurality of power outlets is replaced, determine whether or not device information of a device coupled to the fourth power outlet before the replacement matches device information of a device coupled to the fourth power outlet after the replacement.

5. The information processing system according to claim 3,
wherein the device information received from each of the plurality of devices further includes information of power consumption of the device,
wherein the processor of the management apparatus is further configured to
execute second comparison processing that includes determining whether or not the difference between consumption power consumed at a fifth power outlet among the plurality of power outlets at first timing when at least some of the plurality of devices are in operation, and power supplied from the fifth power outlet at second timing before operation of the plurality of devices is started is smaller than or equal to a predetermined value,
wherein the power control processing includes if determined by the second comparison processing that the difference is smaller than or equal to the predetermined value, stop power supply to the fifth power outlet.

6. The information processing system according to claim 1,
wherein the determination processing includes
before the management apparatus transmits the first packet to the device for each of the plurality of devices, calculating a time length from the management apparatus transmitting a second packet to the device to receiving the second packet, and
determining whether or not to transmit a response to the first packet until the time length passes from a point in time when each of the plurality of devices transmits the first packet.

7. An information processing apparatus for managing a plurality of devices, each of the devices mounted on a rack and coupled to any one of a plurality of power outlets, the information processing apparatus comprising:
a memory; and
a processor coupled to the memory and configured to
execute power control processing that includes stopping power supply to a first power outlet among the plurality of power outlets,
execute determination processing that includes determining whether or not each of the plurality of devices transmits a response to a first packet from the management apparatus to the devices during the power supply to the first power outlet is stopped, and
execute recording processing that includes recording identification information of a device from which a response to the first packet is not received, in association with identification information of the first power outlet.

8. A location identification method performed by a computer for managing a plurality of devices, each of the devices mounted on a rack and coupled to any one of a plurality of power outlets, the method comprising:
executing, by a processor of the computer, power control processing that includes stopping power supply to a first power outlet among the plurality of power outlets,
executing, by the processor of the computer, determination processing that includes determining whether or not each of the plurality of devices transmits a response to a first packet from the management apparatus to the devices during the power supply to the first power outlet is stopped, and
executing, by the processor of the computer, recording processing that includes recording identification information of a device from which a response to the first packet is not received, in association with identification information of the first power outlet.

9. A non-transitory computer-readable storage medium for storing a data transfer program that causes a computer to execute a process, the computer being a computer for managing a plurality of devices, each of the devices mounted on a rack and coupled to any one of a plurality of power outlets, the process comprising:
executing power control processing that includes stopping power supply to a first power outlet among the plurality of power outlets,
executing determination processing that includes determining whether or not each of the plurality of devices transmits a response to a first packet from the management apparatus to the devices during the power supply to the first power outlet is stopped, and
executing recording processing that includes recording identification information of a device from which a response to the first packet is not received, in association with identification information of the first power outlet.
